(19) United States
(12) Patent Application Publication
(10) Pub. No.: US 2007/0076444 A1
(43) Pub. Date: Apr. 5, 2007

(54) Using a variable frequency drive for non-motor loads

(76) Inventors: Thomas Charles Mc Nulty, Ewing, NJ (US); Anand Rangarajan, Princeton, NJ (US)

Correspondence Address: WorldWater & Power Corp, 55 Route 31 S, Pennington, NJ, 08534, US

(21) Appl. No.: 11/541,933

(22) Filed: Oct. 2, 2006

Related U.S. Application Data
(60) Provisional application No. 60/723,269, filed on Oct. 3, 2005.

(51) Int. Cl. H02M 3/335

(52) U.S. Cl. 363/16

(57) ABSTRACT

An apparatus for effectively powering non-motor loads with solar power includes a solar array for producing DC power; a variable frequency drive (VFD) connected to the VFD for converting the solar DC power to AC power; a power transformer connected to the VFD; and a non-motor load connected to the power transformer. The power transformer is selected to provide a desired operating voltage to the non-motor load, typically 120 V. The power transformer may have a primary with a delta configuration and a secondary with a wye configuration. The system can be used to operate incandescent and fluorescent lamps, and to power UPS systems.

### RELATED APPLICATIONS

This application claims priority from Provisional Application Ser. No. 60/723,269 filed Oct. 3, 2005.

### BACKGROUND OF INVENTION

1. Field of the Invention

The invention relates generally to solar power systems, and more particularly to the operation of non-motor loads using solar powered variable frequency drives (VFDs).

2. Description of Related Art

Variable frequency drives (VFDs) are designed for motor loads and are very effective when controlling motors. VFDs allow solar power to be effectively used to operate motors. However little is known concerning use of the VFD's for controlling non-motor loads. Providing a way to operate these loads with VFDs is an important step forward in using solar power.

Most non-motor loads are designed to operate at standard 120 V, 60 Hz. Operation of non-motor loads from the AC power grid is controlled by use of grid voltage, or in case of grid fault, inverter or UPS (uninterruptible power supply) systems. It is restricted as these systems make use of a sine wave generated 60 Hz voltage. They have fixed frequency settings and controlled voltage settings. If battery back up is used for grid fault, battery sizing determines hours of operation, and extended hours requires a large number of batteries either in series or in parallel.

When operating a system from a solar power source, large variations in solar power can occur and low power can shut down the system. The solar powered system will often not provide the 120 V at which most non-motor loads are designed to operate. Thus, while solar power is rapidly increasing in importance as an alternative energy source, technical problems must be overcome to facilitate its use. It would therefore be desirable to provide a way to operate non-motor loads from a solar powered variable frequency drive (VFD).

### SUMMARY OF THE INVENTION

The invention is an apparatus for effectively powering non-motor loads with solar power. The apparatus includes a solar array for producing DC power; a variable frequency drive (VFD) connected to the VFD for converting the solar DC power to AC power; a power transformer connected to the VFD; and a non-motor load connected to the power transformer. The power transformer is selected to provide a desired operating voltage to the non-motor load, typically 120 V.

In a preferred embodiment, the power transformer has a primary with a delta configuration and a secondary with a wye configuration. The power transformer may be configured to provide a 208 V phase voltage and a 120 V phase voltage to neutral. The system of the invention can be used to operate incandescent and fluorescent lamps, and to power UPS systems.

### BRIEF DESCRIPTION OF THE DRAWINGS

In the accompanying drawings:

FIG. 1 is a block diagram of solar powered VFD system of the invention for operating a non-motor load.

FIG. 2 shows a power transformer with a delta-wye configuration.

FIG. 3 shows a UPS system powered by the invention.

### DESCRIPTION OF INVENTION

Solar operated variable frequency drives (VFD's) are very useful in providing AC power during a grid fault or in areas where no AC grid voltage is available. The reason is that power can be made available even at levels of low sunlight if the operating frequency is reduced or if reduced power is acceptable. The output power at a reduced frequency equals the 60 Hz power multiplied by the cube of the ratio of the reduced frequency to the 60 Hz operating frequency. The power is approximately reduced by 5% for every one hertz reduction in frequency. This power advantage is not available for UPS or inverter systems since their output frequency is fixed. The VFD output can range from 60 to 50 Hz, resulting in approximately 50% power reduction, allowing for maximum use of the available solar power. Lower frequency of operation is easily attained and can be used at the reduced power levels.

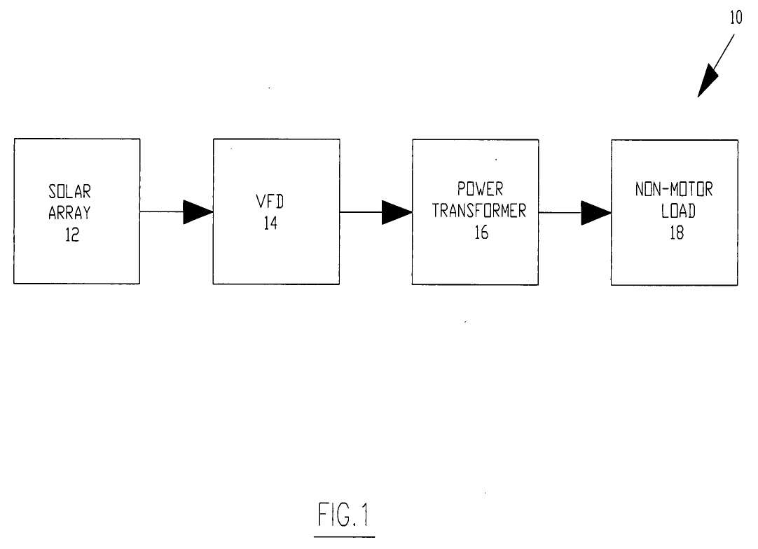

As shown in FIG. 1, a solar powered VFD system 10 of the invention has a solar array 12 as a power source. The DC output of solar array 12 is input into variable speed drive (VFD) 14 to produce a variable speed AC output. The AC power from VFD 14 is input into a power transformer 16 whose output is connected to a non-motor load 18. The transformer 16 is selected to provide the desired voltage to operate the non-motor load 18. Typically the desired voltage is 120 V.

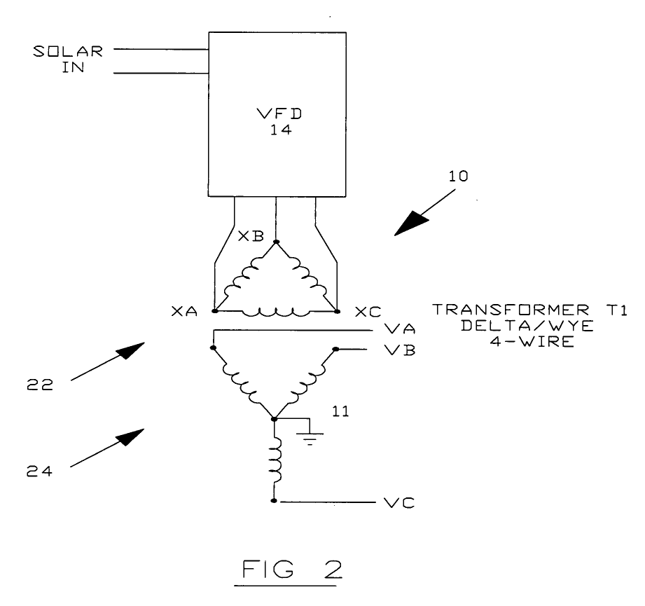

FIG. 2 shows a solar powered VFD drive 14 connected to the primary 20 of a power transformer 22, which has a secondary 24. Transformer 22 is an example of transformer 16 and is selected to provide a suitable output to allow VFD 14 to operate the non-motor load 18.

Standard VFDs have a selectable output of 208 V and 240 V. VFDs for heavy industrial applications have outputs of 480 V. The primary rating of transformer 22 can be 208/240 or 480 3-phase voltages (which match the typical output ratings of VFDs). The secondary 24 can be sized to the load requirement.

In the preferred embodiment illustrated in FIG. 2, the primary 20 has a “delta” configuration and the secondary 24 has a “wye” configuration. XA, XB, XC represent the three phase output voltage from VFD 14. VA, VB, VC represent the three phase output voltage of transformer 22. N is the neutral point of the secondary 24, and the three phase voltage to neutral outputs are represented by VAN, VBN, VCN.

As an example the primary is 240 volts Delta (i.e. XA, XB, XC=240 V) and the secondary is Wye connected as 208 volts (i.e. VA, VB, VC=208 V). This provides a phase voltage to neutral of 120 volts (i.e. VAN, VBN, VCN=120 V) which covers a wide range of control voltages for industrial or commercial use.

The phase voltage can be distributed out for lighting, relays, or other loads. It is similar to an electrical distribution panel. The 120 volt leg is particularly useful as this is the commercial voltage rating for such loads as incandescent or fluorescent lamps.

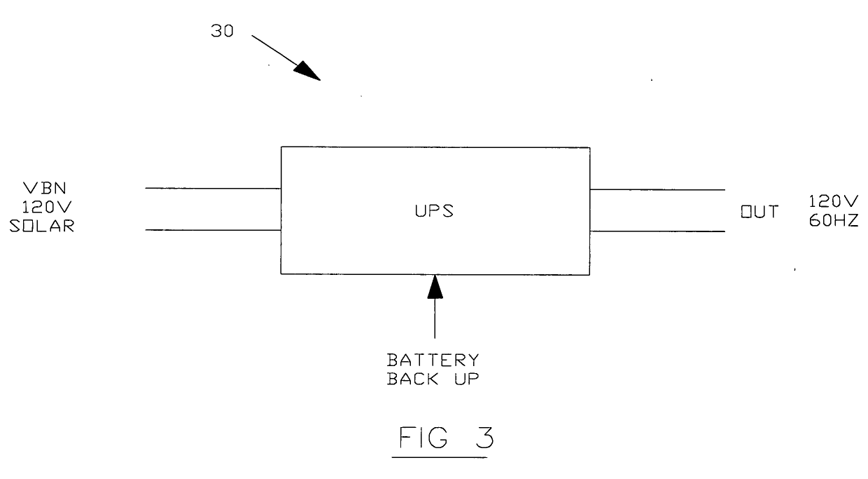

FIG. 3 shows a UPS system 30 controlled by a 120 volt phase to neutral voltage, e.g. VBN from FIG. 2. Higher voltage control can be used if required. However for this design the 120 volt is generally preferred. Primary voltage source for the UPS is normally 60 Hz AC. In the event of a grid fault, AC disconnect, battery back up is provided for continued 60 Hz AC operation. Sizing of the batteries to provide uninterrupted power to the loads becomes a critical issue. Usually minutes or hours is a design limit; otherwise the battery size becomes exceptionally large.

To overcome this limitation the 120 volt source is powered from the phase to neutral leg of the transformer shown in FIG. 2. Since this voltage is powered by the VFD drive and solar powered, it maintains AC voltage at the UPS input terminals and does not require battery backup during solar operation. This method buffers the need for battery backup and utilizes solar during daylight hours. For UPS systems where the topology is DC rectified, input frequency is of less importance, therefore allowing the VFD to go to a lower frequency and supplying sufficient power for the UPS.

Changes and modifications in the specifically described embodiments can be carried out without departing from the scope of the invention which is intended to be limited only by the scope of the appended claims.

1. Apparatus comprising:
a solar array for producing DC power;
a variable frequency drive (VFD) connected to the VFD for converting the solar DC power to AC power;
a power transformer connected to the VFD;
a non-motor load connected to the power transformer.

2. The apparatus of claim 1 wherein the power transformer is selected to provide a desired operating voltage to the non-motor load.

3. The apparatus of claim 2 wherein the operating voltage is 120 V.

4. The apparatus of claim 1 wherein the power transformer has a primary with a delta configuration and a secondary with a wye configuration.

5. The apparatus of claim 4 wherein the power transformer is configured to provide a 208 V phase voltage and a 120 V phase voltage to neutral.

6. The apparatus of claim 1 wherein the load is an incandescent or fluorescent lamp.

7. The apparatus of claim 3 wherein the load is an incandescent or fluorescent lamp.

8. The apparatus of claim 5 wherein the load is an incandescent or fluorescent lamp.

9. The apparatus of claim 1 wherein the load is a UPS system.

10. The apparatus of claim 3 wherein the load is a UPS system.

11. The apparatus of claim 5 wherein the load is a UPS system.
